(19) United States
(12) Patent Application Publication
(10) Pub. No.: US 2026/0230930 A1
(43) Pub. Date: Aug. 6, 2026

(54) WIRELESS COMMUNICATION SYSTEM, WIRELESS COMMUNICATION METHOD, CENTRALIZED CONTROL DEVICE AND CENTRALIZED CONTROL PROGRAM

(71) Applicant: NTT, Inc., Tokyo (JP)

(72) Inventors: Junichi IWATANI, Musashino-shi, Tokyo (JP); Hirantha ABEYSEKERA, Musashino-shi, Tokyo (JP); Yusuke ASAI, Musashino-shi, Tokyo (JP); Shoko SHINOHARA, Musashino-shi, Tokyo (JP); Tomoyuki YAMADA, Musashino-shi, Tokyo (JP); Yasushi TAKATORI, Musashino-shi, Tokyo (JP)

(73) Assignee: NTT, Inc., Tokyo (JP)

(21) Appl. No.: 19/152,148

(22) PCT Filed: Feb. 2, 2023
(86) PCT No.: PCT/JP2023/003455

§ 371 Date: Jul. 30, 2025

(51) Int. Cl. H04W 28/20

(52) U.S. Cl. CPC H04W 28/20

(57) ABSTRACT

A wireless communication system according to an embodiment includes a plurality of base stations that accommodates wireless terminals and a centralized control device that centrally controls each of the base stations, in which the centralized control device includes a utility function calculation unit that calculates, for target wireless terminals accommodated by the base stations, a ratio of an amount of transmittable traffic of the target wireless terminal based on a channel and bandwidth allocated to the base station to an amount of accommodated traffic per target wireless terminal as a utility function, and a change control unit that performs control to change the channel and bandwidth of the base station so as to increase the utility function calculated by the utility function calculation unit.

### TECHNICAL FIELD

The present invention relates to a wireless communication system, a wireless communication method, a centralized control device, and a centralized control program.

### BACKGROUND ART

For example, Resource allocation based on Area Throughput Optimization Policy (RATOP) is known as a method of centrally controlling radio resources such as a frequency bandwidth and a channel used by a base station (AP) of a wireless LAN to maximize effective capacity of the entire system (see, for example, Non Patent Literature 1).

In RATOP, a centralized control device grasps a state of each AP and allocates radio resources such as a frequency channel and a bandwidth to be used by each AP.

For example, RATOP defines, as an evaluation index for allocating radio resources, a ratio (utility function) of an estimated amount of transmittable traffic (amount of transmittable traffic) based on allocated radio resources (channel and bandwidth) to an estimated value of an amount of maximum traffic (amount of accommodated traffic) of each AP. The centralized control device then performs control to maximize a total value of the utility function.

### CITATION LIST

### Non Patent Literature

Non Patent Literature 1: B. A. Hirantha Sithira Abeysekera et al., “Network Controlled Frequency Channel and Bandwidth Allocation Scheme for IEEE 802.11a/n/ac Wireless LANs: RATOP”, 2014 IEEE 25th International Symposium on Personal, Indoor and Mobile Radio Communications, pp. 1041-1045

### SUMMARY OF INVENTION

### Technical Problem

However, in the method of centrally controlling radio resources such as RATOP, control considering an amount of traffic for each wireless terminal accommodated by a base station has not been sufficiently examined.

An object of the present invention is to provide a wireless communication system, a wireless communication method, a centralized control device, and a centralized control program capable of performing centralized control so as to optimize allocation of radio resources to a base station in accordance with traffic of a wireless terminal accommodated by the base station.

### Solution to Problem

A wireless communication system according to an embodiment of the present invention is a wireless communication system including a plurality of base stations that accommodates wireless terminals and a centralized control device that centrally controls each of the base stations, in which the centralized control device includes a utility function calculation unit that calculates, for target wireless terminals accommodated by the base stations, a ratio of an amount of transmittable traffic of the target wireless terminal based on a channel and bandwidth allocated to the base station to an amount of accommodated traffic per target wireless terminal as a utility function, and a change control unit that performs control to change the channel and bandwidth of the base station so as to increase the utility function calculated by the utility function calculation unit.

A wireless communication method according to an embodiment of the present invention is a wireless communication method of centrally controlling each of a plurality of base stations that accommodates wireless terminals, the wireless communication method including: a utility function calculation step of calculating, for target wireless terminals accommodated by the base stations, a ratio of an amount of transmittable traffic of the target wireless terminal based on a channel and bandwidth allocated to the base station to an amount of accommodated traffic per target wireless terminal as a utility function; and a change control step of performing control to change the channel and bandwidth of the base station so as to increase the utility function calculated in the utility function calculation step.

A centralized control device according to an embodiment of the present invention is a centralized control device that centrally controls each of a plurality of base stations that accommodates wireless terminals, the centralized control device including: a utility function calculation unit that calculates, for target wireless terminals accommodated by the base stations, a ratio of an amount of transmittable traffic of the target wireless terminal based on a channel and bandwidth allocated to the base station to an amount of accommodated traffic per target wireless terminal as a utility function; and a change control unit that performs control to change the channel and bandwidth of the base station so as to increase the utility function calculated by the utility function calculation unit.

### Advantageous Effects of Invention

According to the present invention, it is possible to perform centralized control so as to optimize allocation of radio resources to a base station in accordance with traffic of a wireless terminal accommodated by the base station.

### BRIEF DESCRIPTION OF DRAWINGS

FIG. 1 shows a configuration example of a wireless communication system according to an embodiment.

FIG. 2 shows a specific example of a RATOP algorithm executed by a centralized control device.

FIG. 3 is a functional block diagram showing functions of a centralized control device according to an embodiment.

FIG. 4 is a flowchart showing an operation example of the wireless communication system according to the embodiment.

FIG. 5 shows a hardware configuration of the centralized control device according to the embodiment.

### DESCRIPTION OF EMBODIMENTS

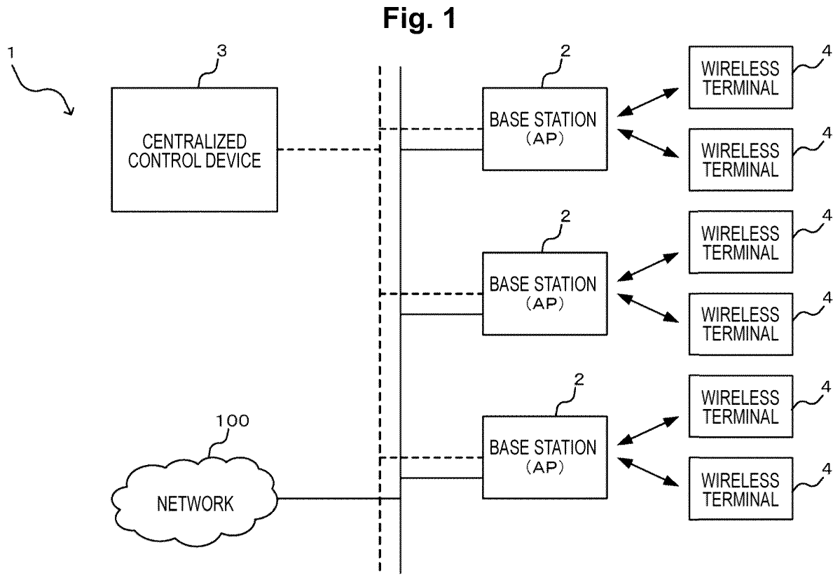

Hereinafter, a wireless communication system according to an embodiment will be described with reference to the drawings. FIG. 1 shows a configuration example of a wireless communication system 1 according to an embodiment. As shown in FIG. 1, the wireless communication system 1 according to the embodiment includes, for example, a plurality of base stations (APs) 2, a centralized control device 3, and a plurality of wireless terminals 4 connected to a network 100. Each of the base stations 2 is centrally controlled by the centralized control device 3 to accommodate a plurality of wireless terminals 4. Hereinafter, the base station may also be referred to as an AP.

The centralized control device 3 performs RATOP control on the plurality of base stations 2. At this time, an index of the control is assumed to be a utility function U (=corresponding to a degree of satisfaction) in Equation (1) below.

$$\begin{matrix}[ Math . 1 ] & \\ {U}_{( b , c )}^{( a )} = \frac{\begin{matrix}( Amount of transmittable traffic when \\ using bandwidth b and channel c {Φ}_{( b , c , R )}^{( a )}\end{matrix}}{Amount of accomodated traffic {θ}^{( a )}} & ( 1 )\end{matrix}$$

a: identifier of AP
b: bandwidth
c: channel (primary channel)
R: data rate (MCS)

The amount of transmittable traffic of the AP (a) depends on a channel usage state or the like of another AP. The amount of accommodated traffic (which depends on an amount of generated data) is, for example, a maximum traffic estimation value of the AP (a) expressed by Equation (2) below.

$$\begin{matrix}[ Math . 2 ] & \\ Maximum traffic estimation value of Ap ( a ) ( = min ( amount of generated data , amount of transmittable traffic when there is no another AP in surroundings ) ) & ( 2 )\end{matrix}$$

At this time, the maximum traffic estimation value may be assumed to be the amount of accommodated traffic per wireless terminal x the number of assumed wireless terminals. The centralized control device 3 then performs processing of maximizing a total ZU of the utility functions U according to the following algorithm.

### RATOP Algorithm:

(A): The centralized control device 3 “temporarily allocates” a channel and bandwidth to be used by each AP according to a predetermined rule.
(B): The centralized control device 3 calculates the total ZU of the utility functions U of the respective APs in the above case (A).
(C): The centralized control device 3 reallocates the channel and bandwidth to an AP having a low utility function U and performs control so as not to decrease ZU. The centralized control device 3 then repeats the above (C) within a predetermined condition range.

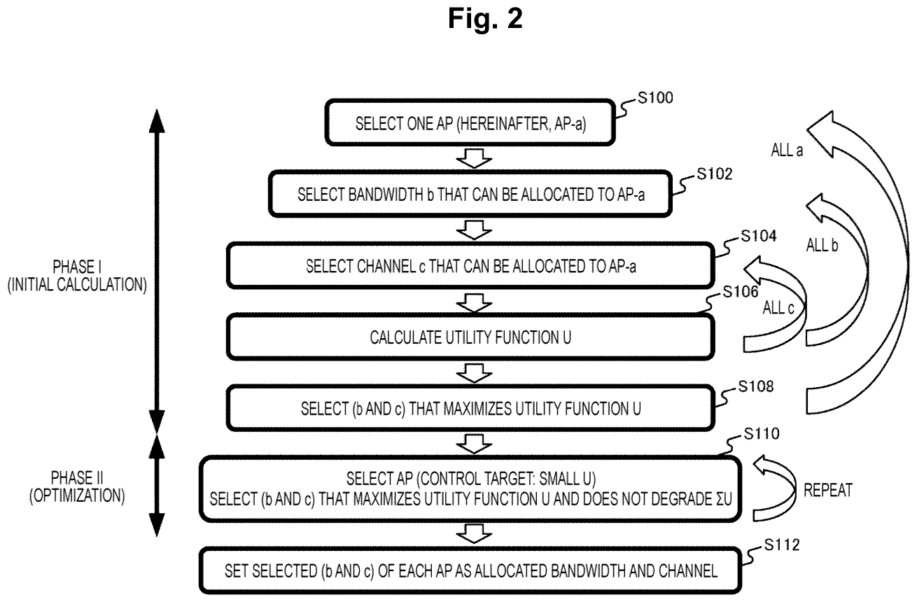

FIG. 2 shows a specific example of a RATOP algorithm executed by the centralized control device 3. As shown in FIG. 2, the centralized control device 3 performs processing of a phase I (initial calculation) and a phase II (optimization).

In the phase I, the centralized control device 3 selects one AP as AP-a (S100), selects the bandwidth b that can be allocated to AP-a (S102), selects the channel (primary channel) c that can be allocated to AP-a (S104), and calculates the utility function U of AP-a (S106).

The centralized control device 3 then executes the processing in S104 and the processing in S106 for all the channels c and further repeats the processing for all the bandwidths b.

Next, the centralized control device 3 selects a combination (b and c) that maximizes the utility function U (S108) and repeats the processing for all the APs.

In the phase II, for example, after selecting an AP having a small utility function U, the centralized control device 3 repeats the processing of selecting a combination (parameter) of (b and c) that maximizes the utility function U and does not degrade the total ZU of the utility functions U (S110).

The centralized control device 3 then sets the selected combination (b and c) of each AP as a controlled allocated bandwidth and channel.

The wireless communication system 1 may also perform centralized control by using a utility function for traffic of each wireless terminal instead of (or in combination with) the above utility function for traffic of each AP.

Hereinafter, the utility function for the traffic of each AP will be referred to as a base station utility function U, and the utility function for the traffic of each wireless terminal will be referred to as a utility function V for distinction.

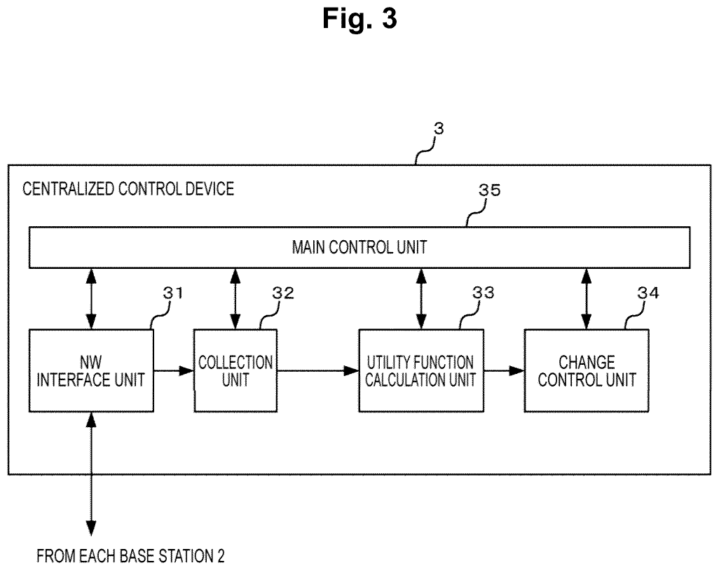

FIG. 3 is a functional block diagram showing functions of the centralized control device 3 according to the embodiment. As shown in FIG. 3, the centralized control device 3 includes, for example, an NW interface unit 31, a collection unit 32, a utility function calculation unit 33, a change control unit 34, and a main control unit 35.

The NW interface unit 31 transmits and receives control information to and from each base station 2.

The collection unit 32 collects information regarding each base station 2 and each wireless terminal 4 via the NW interface unit 31 and outputs the information to the utility function calculation unit 33. For example, the collection unit 32 collects information such as a position of the base station 2, the number and positions of the wireless terminals 4 connected to each base station 2, and traffic (e.g. uplink/downlink ratio).

The utility function calculation unit 33 has a function of calculating, for a target wireless terminal accommodated by each base station 2, a ratio of an amount of transmittable traffic of the target wireless terminal based on a channel and bandwidth allocated to the base station 2 to an amount of accommodated traffic per target wireless terminal as the utility function V and outputting the utility function V to the change control unit 34.

The utility function V is obtained by replacing the amount of transmittable traffic with the “amount of transmittable traffic of the target wireless terminal (e.g. one target wireless terminal or an average of a plurality of target wireless terminals) accommodated by the base station 2” and replacing the amount of accommodated traffic with “corresponding to the amount of accommodated traffic per target wireless terminal accommodated by the base station 2” in the base station utility function U.

Specifically, the utility function V is expressed by Equation (3) below.

$$\begin{matrix}[ Math . 3 ] & \\ {V}_{( b , c )}^{( a )} = \frac{\begin{matrix}( Amount of transmittable traffic of target terminal \\ when using bandwidth b and channel C {Φ}_{( b , c , R )}^{( a )}\end{matrix}}{Amount of accomodated traffic of target terminal {θ}^{( a )}} & ( 3 )\end{matrix}$$

At this time, the utility function calculation unit 33 sets at least one of a necessary amount of downlink traffic and a necessary amount of uplink traffic in the target wireless terminal as a target of the amount of accommodated traffic and the amount of transmittable traffic. That is, the utility function calculation unit 33 may set only the necessary amount of downlink traffic in the target wireless terminal as the amount of accommodated traffic or may set the amount of downlink traffic and the amount of uplink traffic as the amount of accommodated traffic. Further, the utility function calculation unit 33 may calculate the utility function V of the amount of downlink traffic and the utility function V of the amount of uplink traffic, assuming ratios of the amounts of downlink traffic and the amounts of uplink traffic.

The utility function calculation unit 33 selects, as the target wireless terminal, one wireless terminal 4 having an unsatisfactory condition for performing wireless communication from among the plurality of wireless terminals 4 accommodated by the base station 2. For example, the utility function calculation unit 33 selects the target wireless terminal on the basis of the position of the wireless terminal 4 such as the wireless terminal 4 far from the base station 2. The utility function calculation unit 33 may also set an average value of the amounts of traffic of the plurality of wireless terminals 4 as an amount of traffic of the target wireless terminal.

The utility function calculation unit 33 calculates, for example, the amounts of transmittable downlink and uplink traffic in the target wireless terminal on the basis of positions and the number of the surrounding base stations 2 and wireless terminals 4. The amount of transmittable traffic also depends on positions of other surrounding base stations 2 and wireless terminals 4 and a use state of the radio resources.

The utility function calculation unit 33 further has a function of calculating a ratio of the amount of transmittable traffic based on the allocated channel and bandwidth to the amount of accommodated traffic per base station 2 as the base station utility function U and outputting the base station utility function U to the change control unit 34.

The utility function calculation unit 33 may be set to calculate only the utility function V or may be set to calculate the utility function V and the base station utility function U.

The change control unit 34 performs control to change the channel and bandwidth of the base station 2 so as to increase the utility function V calculated by the utility function calculation unit 33.

In a case where the utility function calculation unit 33 is set to calculate the utility function V and the base station utility function U, the change control unit 34 performs control to change the channel and bandwidth of the base station 2 so as to increase a total result of multiplying the utility function V and the base station utility function U calculated by the utility function calculation unit 33 by a predetermined weighting coefficient.

For example, the change control unit 34 calculates a new utility function (==aU+(1−a)V) for the base station 2 by using the utility function (V) and the base station utility function (U). Here, the coefficient a (0 to 1) is assumed to be a setting parameter.

That is, for example, in the processing in S108 of FIG. 2, the change control unit 34 may perform control to maximize the utility function (V) instead of the base station utility function (U) or may perform control by weighting the utility function V and the base station utility function U by using the coefficient a.

The main control unit 35 controls each unit of the centralized control device 3.

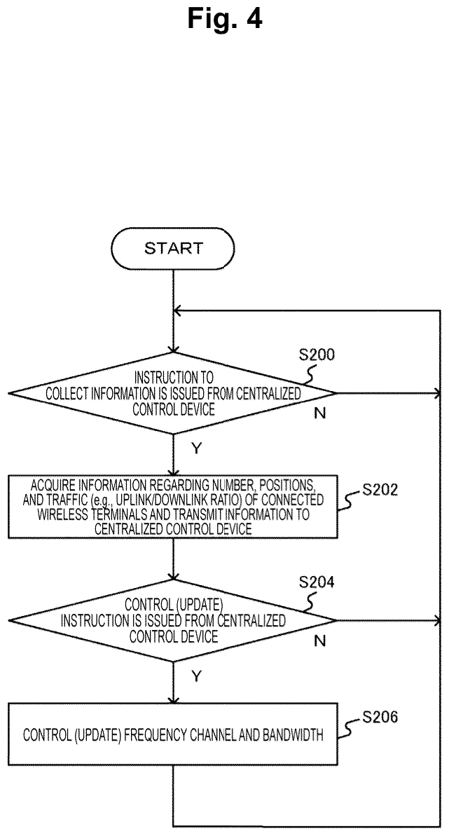

FIG. 4 is a flowchart showing an operation example of the wireless communication system 1 according to the embodiment. First, the base station 2 determines whether or not an instruction to collect information is issued from the centralized control device 3 (S200). If the instruction is issued (S200: Yes), the processing proceeds to S202, and if the instruction is not issued (S200: No), the processing in S200 is repeated.

In step 202 (S202), the base station 2 acquires information regarding the number, positions, and traffic (e.g. uplink/downlink ratio) of the connected wireless terminals 4 and transmits the information to the centralized control device 3.

In step 204 (S204), the base station 2 determines whether or not a control instruction to update the bandwidth b and the channel c of the wireless terminal 4 (or a control instruction to update distribution of the traffic) is issued from the centralized control device 3. When determining that the control instruction is issued (S204: Yes), the base station 2 proceeds to the processing in S206, and when determining that the control instruction is not issued (S204: No), the base station 2 returns to the processing in S200.

In step 206 (S206), the base station 2 performs change control to change the bandwidth b and the channel c (or control to update the distribution of the traffic) and returns to the processing in S200.

As described above, in the wireless communication system 1 according to the embodiment, the centralized control device calculates the utility function for the target wireless terminal accommodated by the base station and performs control to change the channel and bandwidth of the base station so as to increase the utility function. This makes it possible to perform centralized control to optimize allocation of the radio resources to the wireless terminal accommodated by the base station.

Some or all of the functions of the centralized control device 3 may be configured with hardware such as a programmable logic device (PLD) or a field programmable gate array (FPGA) or may be configured as a program executed by a processor such as a CPU.

For example, the centralized control device 3 can be implemented by using a computer and a program, and the program can be recorded in a storage medium or be provided through a network.

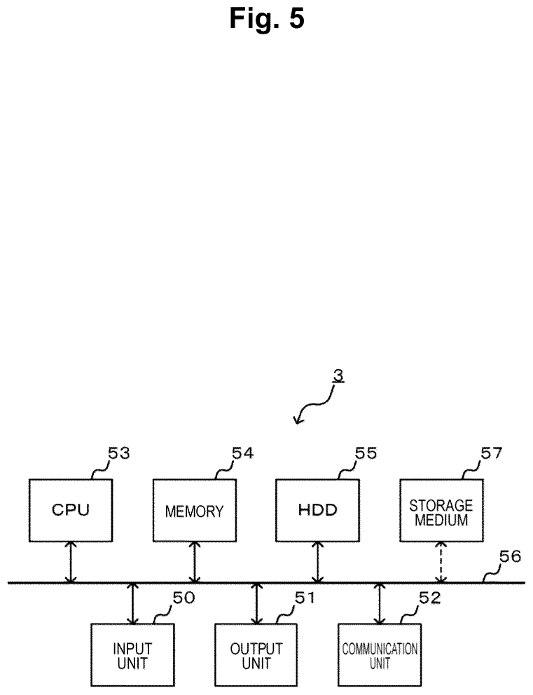

FIG. 5 shows a hardware configuration of the centralized control device 3 according to the embodiment. As shown in FIG. 5, the centralized control device 3 has a function as a computer in which an input unit 50, an output unit 51, a communication unit 52, a CPU 53, a memory 54, and an HDD 55 are connected via a bus 56. The centralized control device 3 can input and output data to and from a computer-readable storage medium 57.

The input unit 50 is, for example, a keyboard and a mouse. The output unit 51 is, for example, a display device such as a display.

The communication unit 52 is, for example, a communication interface that communicates with a wireless device to be controlled.

The CPU 53 controls each unit of the centralized control device 3 and performs predetermined processing and the like. The memory 54 and the HDD 55 store data and the like.

The storage medium 57 can store, for example, a program for executing the functions of the centralized control device 3. An architecture configuring the centralized control device 3 is not limited to the example in FIG. 5.

### REFERENCE SIGNS LIST

1 Wireless communication system
2 Base station
3 Centralized control device
4 Wireless terminal
31 NW interface unit
32 Collection unit
33 Utility function calculation unit
34 Change control unit
35 Main control unit
50 Input unit
51 Output unit
52 Communication unit
53 CPU
54 Memory
55 HDD
56 Bus
57 Storage medium
100 Network

1. A wireless communication system including a plurality of base stations that accommodates wireless terminals and a centralized control device that centrally controls each of the base stations, wherein
the centralized control device includes
utility function calculation circuitry configured to calculate, for target wireless terminals accommodated by the base stations, a ratio of an amount of transmittable traffic of the target wireless terminal based on a channel and bandwidth allocated to the base station to an amount of accommodated traffic per target wireless terminal as a utility function, and
change control circuitry configured to perform control to change the channel and bandwidth of the base station so as to increase the utility function calculated by the utility function calculation circuitry.

2. The wireless communication system according to claim 1, wherein
the utility function calculation circuitry sets at least one of an amount of downlink traffic or an amount of uplink traffic in the target wireless terminal as a target of the amount of accommodated traffic and the amount of transmittable traffic.

3. The wireless communication system according to claim 1, wherein:
the utility function calculation circuitry further calculates a ratio of the amount of transmittable traffic based on the allocated channel and bandwidth to the amount of accommodated traffic per base station as a base station utility function; and
the change control circuitry performs control to change the channel and bandwidth of the base station so as to increase a result of multiplying the utility function and the base station utility function calculated by the utility function calculation circuitry by a predetermined weighting coefficient.

4. A wireless communication method of centrally controlling each of a plurality of base stations that accommodates wireless terminals, the wireless communication method comprising:
calculating, for target wireless terminals accommodated by the base stations, a ratio of an amount of transmittable traffic of the target wireless terminal based on a channel and bandwidth allocated to the base station to an amount of accommodated traffic per target wireless terminal as a utility function; and
performing control to change the channel and bandwidth of the base station so as to increase the utility function calculated in the calculating.

5. A centralized control device that centrally controls each of a plurality of base stations that accommodates wireless terminals, the centralized control device comprising:
utility function calculation circuitry configured to calculate, for target wireless terminals accommodated by the base stations, a ratio of an amount of transmittable traffic of the target wireless terminal based on a channel and bandwidth allocated to the base station to an amount of accommodated traffic per target wireless terminal as a utility function; and
change control circuitry configured to perform control to change the channel and bandwidth of the base station so as to increase the utility function calculated by the utility function calculation circuitry.

6. The centralized control device according to claim 5, wherein
the utility function calculation circuitry sets at least one of an amount of downlink traffic or an amount of uplink traffic in the target wireless terminal as a target of the amount of accommodated traffic and the amount of transmittable traffic.

7. The centralized control device according to claim 5, wherein:
the utility function calculation circuitry further calculates a ratio of the amount of transmittable traffic based on the allocated channel and bandwidth to the amount of accommodated traffic per base station as a base station utility function; and
the change control circuitry performs control to change the channel and bandwidth of the base station so as to increase a result of multiplying the utility function and the base station utility function calculated by the utility function calculation circuitry by a predetermined weighting coefficient.

8. A non-transitory computer-readable storage medium storing a centralized control program for causing a computer to function as each circuitry of the centralized control device according to claim 5.
